(19) United States
(12) Patent Application Publication
(10) Pub. No.: US 2022/0371077 A1
(43) Pub. Date: Nov. 24, 2022

(54) Method of Automating Coil Height Control in a Wire Rod Plant

(71) Applicant: PRIMETALS TECHNOLOGIES USA LLC, Alpharetta, GA (US)

(72) Inventors: Matthew D. Palfreman, Charlton, MA (US); Paul Barry Riches, Paxton, MA (US)

(73) Assignee: PRIMETALS TECHNOLOGIES USA LLC, Alpharetta, GA (US)

(21) Appl. No.: 17/326,586

(22) Filed: May 21, 2021

(51) Int. Cl. B21F 3/08; G06K 9/00; G01B 11/02

(52) U.S. Cl. CPC B21F 3/08; G06K 9/00771; G01B 11/02

(57) ABSTRACT

Automated height control and coil formation in wire rod mills are described within, where improvements in vision systems and smart sensors are leveraged to enable real-time control of both coil formation and coil height, without the need for secondary inspection and operator input from the pulpit.

### BACKGROUND OF THE INVENTION

### Field of Invention

The present invention relates generally to wire rod mills. More specifically, the present invention is related to automating coil height and coil formation in a wire rod mill.

### Discussion of Prior Art

Of a critical nature to many wire rod mill plants is the coil formation and coil height of the final product that leaves the mill. Coil formation is critical for efficient unwinding at downstream processing facilities, whilst coil height needs to be controlled for logistical reasons. The shorter the coil the more coils per container or truck can be transported, thus reducing costs.

In a wire rod mill, coil height (and thus coil form) varies from rod to rod as there are many factors at play, including the speed of the conveyor feeding the reform station based on the products required cooling rate, the speed of the product distributor in the reform tub, and the coil formation itself at the laying head.

In the prior art, none of these functions interacts with the other since they are all manual pre-sets. Accordingly, the prior art lacks any automated functionality in the controlling, monitoring or adjustment of many of the above-identified factors. Control in the prior art is manual from the main pulpit or from a local station.

Also, over the years various techniques have been developed to reduce the coil height in wire rod mills. However, these developments have centered around the equipment used to collect the wire from the cooling conveyor and repackage it as a finished coil.

Whatever the precise merits, features, and advantages of the above cited references, none of them achieves or fulfills the purposes of the present invention.

### SUMMARY OF THE INVENTION

In one embodiment, the present invention provides a method comprising: (a) calculating a coil formation rate (CFR) from a coil plate descent speed (CPDS) and an accumulation rate (AR) in a reform area of a wire rod mill; (b) when the CFR is below a threshold, either: (b1) increasing the CPDS by a first predetermined amount; or (b2) increasing a ring distributor speed (RDS) by a second predetermined amount and decreasing a coil plate speed (CPS) by a third predetermined amount; and (c) sampling the AR in the reform area and iteratively performing steps (a) and (b) until accumulated coil height is below an optimal coil height and the CFR is no longer below the threshold in response to (b1) or (b2).

In another embodiment, the present invention provides a method comprising: (a) calculating a coil formation rate (CFR) from a coil plate descent speed (CPDS) and an accumulation rate (AR) in a reform area of a wire rod mill; (b) when the CFR is below a threshold, increasing the CPDS by a first predetermined amount, increasing a ring distributor speed (RDS) by a second predetermined amount, and decreasing a coil plate speed (CPS) by a third predetermined amount; and (c) sampling the AR in the reform area and iteratively performing steps (a) and (b) until accumulated coil height is below an optimal coil height and the CFR is no longer below the threshold in response to (b).

In yet another embodiment, the present invention provides a system comprising: (a) a plurality of cameras monitoring coil height and coil formation in a reform area of a wire rod mill; (b) a storage storing computer readable program code; (c) a processor executing the computer readable program code stored in the storage to: (1) receive data from the plurality of cameras; (2) calculate a coil plate descent speed (CPDS) and an accumulation rate (AR) from received data from the plurality of cameras; (3) calculate a coil formation rate (CFR) from the CPDS and the AR; (4) when the CFR is below a threshold, either: increase the CPDS by a first predetermined amount; or increase a ring distributor speed (RDS) by a second predetermined amount and decrease a coil plate speed (CPS) by a third predetermined amount; and (5) sample the AR in the reform area and iteratively repeat (1) through (4) until accumulated coil height is below an optimal coil height and the CFR is no longer below the threshold in response to (4).

In another embodiment, the present invention provides a system comprising: (a) a plurality of cameras monitoring coil height and coil formation in a reform area of a wire rod mill; (b) a storage storing computer readable program code; (c) a processor executing the computer readable program code stored in the storage to: (1) receive data from the plurality of cameras; (2) calculate a coil plate descent speed (CPDS) and an accumulation rate (AR) from received data from the plurality of cameras; (3) calculate a coil formation rate (CFR) from the CPDS and the AR; (4) when the CFR is below a threshold: increase the CPDS by a first predetermined amount; increase a ring distributor speed (RDS) by a second predetermined amount, and decrease a coil plate speed (CPS) by a third predetermined amount; and (5) sample the AR in the reform area and iteratively repeat (1) through (4) until accumulated coil height is below an optimal coil height and the CFR is no longer below the threshold in response to (4).

### BRIEF DESCRIPTION OF THE DRAWINGS

FIG. 1(A) depicts a desired coil formation in a wire rod mill.

FIG. 1(B) depicts an undesirable, stepped coil formation in a wire rod mill.

FIG. 1(C) depicts such an undesirable, slanted formation.

FIG. 2 depicts the system of the present invention to ensure height control.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides for the monitoring of the coil height formation with a laser and camera (or a plurality of cameras) to control a coil plate descent rate, ring distributor operation speeds and, on large sizes, a wobble at the laying head or cooling conveyor entry speed to the reform tub. The present invention provides an algorithm needed to control each function that can affect coil height.

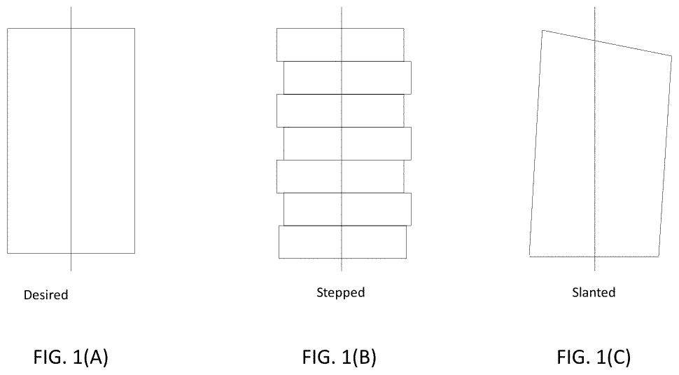

FIG. 1(A) depicts a desired coil formation in a wire rod mill. However, when a ring distributor is too slow relative to a coil plate descent rate, steps may be introduced in the coil formation. FIG. 1(B) depicts such an undesirable, stepped formation. In the present invention, such a stepped formation may be detected by one camera and verified by another camera (or a coil height laser), whereby the distributor speed may be increased iteratively until the steps are no longer visible.

Yet another undesirable coil formation in a wire rod mill is a situation in which the coil's top is sloped, indicating that the coil plate is travelling too fast and a combination of ring distributor speed and coil plate speed is incorrect. FIG. 1(C) depicts such an undesirable, slanted formation.

For wobbled coils, if the coil measures too tall, the wobble settings at the laying head could be adjusted. In this case the percent change of diameter between the rings could be increased incrementally from coil to coil.

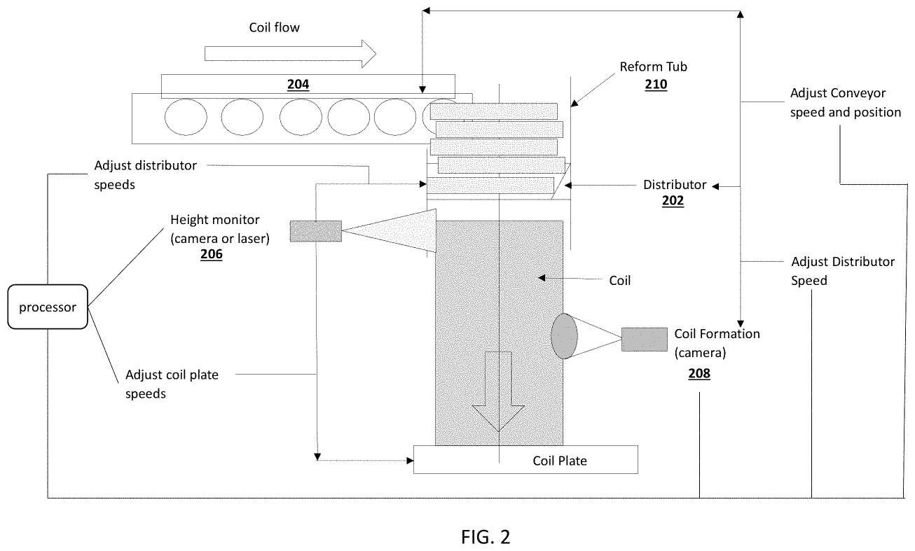

FIG. 2 depicts the system of the present invention. Development to the “reform” station (named as it reforms the wire from the cooling conveyor to a coil) have been the main focus with the introduction of ring distributor 202 and the stepless reform.

Ring distributor 202, as its name implies, distributes the individual rings of the coil as they are gathered from the conveyor 204 and ensure the reform area is filled correctly and densely creating a shorter coil than randomly falling rings. The speed of this device is variable but only adjusted by operators after inspection of the completed coil formation at an inspection station.

Stepless reform was developed to improve coil shape by eliminating any dropping of the coil during its forming process and accurately controlling the descent of the coil plates within in the correct parameters as the coil body itself is formed in the reform chamber. This descent rate is controlled via sensors located in the reform tub, as descent of the coil is critical to its overall height and formation.

The present invention provides automated coil formation and height control taking advantage of improvements in vision systems and smart sensors to enable real-time control of both coil formation and coil height, without the need for secondary inspection and operator input from the pulpit.

The laying head control does play a large part in the coil formation as it creates the rings that eventually form the coil. However, for this disclosure, it is assumed that the machine is operating as it should.

The present invention utilizes a smart camera and/or a laser 206 that can measure the coil height. Optionally, two cameras could be employed, a first camera 208 to monitor formation and a second camera 206 to measure height.

To control the coil height the following basic control would be employed. Optimum coil height is considered to be 0.9-1 m/tone of wire rod. In one embodiment, optimal coil height is derived from empirical data of the best-known heights achievable, for a standard reform tub/coil form (1250 ID/850 OD) this height to weight ratio allows tangle free processing of the coil.

According to the present invention, the coil plate descent speed would be correlated with the accumulation rate measured in the reform tub 210 via a laser or a camera system 208. Based on these two signals, a coil formation rate is calculated in kg/s and compared to a predefined ideal rate. If this rate is too low, then the coil descent speed is increased and/or the ring distributor and coil plate speeds are changed. If the rate is too low, then the ring distributor speed is increased and the coil plate speed decreased. The collection rate in the reform area is then sampled (every 10 s, for example) to ensure the system is stable and the coils height is optimal.

The coil formation camera 208 may be operational in parallel to the above-described process, as the coil formation camera 208 may check the outer edge of the coil to ensure it is being formed smooth and that all coils are falling perpendicular to the coil plate and reform chamber axis.

The present invention's control may be linked to ring distributor 202, the exit zone of the cooling conveyor, and the coil plate descent control rate.

It should be noted that the coil height control is the primary driver as per the present invention, as the coil formation is a, secondary, slave function.

If a stepped coil formation is detected, there may be two possible causes: the ring distributor speed is too slow causing the rings from the cooling conveyor to clump or the descent rate of the coil plate is variable (i.e., speeding up and slowing down in a sinusoidal manner, for example). Upon detecting the stepped formation, the present invention's control would first increase the ring distributor speed to remove the steps and check the coil descent control for an even descent rate.

If the rings are being formed in a slanted manner, the exit zone of the cooling conveyors position would be adjusted relative to the reform area and/or the exit roller speed of the cooling conveyor modified to ensure the rings are entering the reform area at the correct velocity.

As an addition to the simple system described above the data and or images collected can be complied to be used as a quality assurance database.

In one embodiment, the present invention provides a method comprising: (a) calculating a coil formation rate (CFR) from a coil plate descent speed (CPDS) and an accumulation rate (AR) in a reform area of a wire rod mill; CFR is based on the optimal coil to weight ratio (the product being rolled is a known quantity and the ton/hour rolling rate is also a known quantity; the height of the coil is measured; if the system is above 0.9 m/ton, the RDS speed is increased and the coil plate is slowed); (b) when the CFR is below a threshold, either: (b1) increasing the CPDS by a first predetermined amount; or (b2) increasing a ring distributor speed (RDS) by a second predetermined amount and decreasing a coil plate speed (CPS) by a third predetermined amount; and (c) sampling the AR in the reform area and iteratively performing steps (a) and (b) until accumulated coil height is below an optimal coil height (optimal coil height is 0.9 m to 1.0 m/ton of rod weight as noted earlier for transport and unwinding) and the CFR is no longer below the threshold in response to (b1) or (b2).

As an example, rolling 5.5 mm the RDS would be set to 25 rpm, the CPS would be in the region of 0.01 m/s, this equates roughly to the CFR of 1 m/ton of rod material. If for example the CFR was measured at 0.8 m/ton then the CPS would increase in steps of 2% and the RDS slow down in steps of 2%, until the CFR of 1 m/ton was achieved.

In another embodiment, the present invention provides a method comprising: (a) calculating a coil formation rate (CFR) from a coil plate descent speed (CPDS) and an accumulation rate (AR) in a reform area of a wire rod mill; (b) when the CFR is below a threshold, increasing the CPDS by a first predetermined amount, increasing a ring distributor speed (RDS) by a second predetermined amount, and decreasing a coil plate speed (CPS) by a third predetermined amount; and (c) sampling the AR in the reform area and iteratively performing steps (a) and (b) until accumulated coil height is below an optimal coil height and the CFR is no longer below the threshold in response to (b).

In yet another embodiment, the present invention provides a system comprising: (a) a plurality of cameras monitoring coil height and coil formation in a reform area of a wire rod mill; (b) a storage storing computer readable program code; (c) a processor executing the computer readable program code stored in the storage to: (1) receive data from the plurality of cameras; (2) calculate a coil plate descent speed (CPDS) and an accumulation rate (AR) from received data from the plurality of cameras; (3) calculate a coil formation rate (CFR) from the CPDS and the AR; (4) when the CFR is below a threshold, either: increase the CPDS by a first predetermined amount; or increase a ring distributor speed (RDS) by a second predetermined amount and decrease a coil plate speed (CPS) by a third predetermined amount; and (5) sample the AR in the reform area and iteratively repeat (1) through (4) until accumulated coil height is below an optimal coil height and the CFR is no longer below the threshold in response to (4).

In another embodiment, the present invention provides a system comprising: (a) a plurality of cameras monitoring coil height and coil formation in a reform area of a wire rod mill; (b) a storage storing computer readable program code; (c) a processor executing the computer readable program code stored in the storage to: (1) receive data from the plurality of cameras; (2) calculate a coil plate descent speed (CPDS) and an accumulation rate (AR) from received data from the plurality of cameras; (3) calculate a coil formation rate (CFR) from the CPDS and the AR; (4) when the CFR is below a threshold: increase the CPDS by a first predetermined amount; increase a ring distributor speed (RDS) by a second predetermined amount, and decrease a coil plate speed (CPS) by a third predetermined amount; and (5) sample the AR in the reform area and iteratively repeat (1) through (4) until accumulated coil height is below an optimal coil height and the CFR is no longer below the threshold in response to (4).

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method has been shown in the above embodiments for the effective implementation of a system and method of automating coil height control in a wire rod plant. While various preferred embodiments have been shown and described, it will be understood that there is no intent to limit the invention by such disclosure, but rather, it is intended to cover all modifications and alternate constructions falling within the spirit and scope of the invention, as defined in the appended claims.

1. A method comprising:
(a) calculating a coil formation rate (CFR) from a coil plate descent speed (CPDS) and an accumulation rate (AR) in a reform area of a wire rod mill;
(b) when the CFR is below a threshold, either:
(b1) increasing the CPDS by a first predetermined amount; or
(b2) increasing a ring distributor speed (RDS) by a second predetermined amount and decreasing a coil plate speed (CPS) by a third predetermined amount; and
(c) sampling the AR in the reform area and iteratively performing steps (a) and (b) until accumulated coil height is below an optimal coil height and the CFR is no longer below the threshold in response to (b1) or (b2).

2. The method of claim 1, wherein the method further comprises the steps of calculating the CPDS and the AR from data gathered from a first camera monitoring coil formation in the wire rod mill and a second camera or a laser measuring coil height in the wire rod mill.

3. The method of claim 2, wherein the first camera checks an outer edge of coils being deposited in a coil plate in the reform area of the wire rod mill to ensure it is being formed smooth and that coils are falling perpendicular to the coil plate and a reform chamber axis.

4. The method of claim 2, wherein the method further comprises:
detecting, via the first camera, a stepped coil formation based on either of these, or a combination of these, conditions: (1) the RDS is slow causing coil rings from a cooling conveyor to clump, or (2) the CPDS is variable; and
increasing the RDS by a fourth predetermined amount and checking if the CPDS is no longer variable.

5. The method of claim 2, wherein the method further comprises:
detecting, via the first camera, coil rings are formed in a slanted manner; and
adjusting a position of a cooling conveyor relative to the reform area and/or modifying an exit roller speed of the cooling conveyor to ensure coil rings are entering the reform area at a predetermined speed.

6. A method comprising:
(a) calculating a coil formation rate (CFR) from a coil plate descent speed (CPDS) and an accumulation rate (AR) in a reform area of a wire rod mill;
(b) when the CFR is below a threshold, increasing the CPDS by a first predetermined amount, increasing a ring distributor speed (RDS) by a second predetermined amount, and decreasing a coil plate speed (CPS) by a third predetermined amount; and
(c) sampling the AR in the reform area and iteratively performing steps (a) and (b) until accumulated coil height is below an optimal coil height and the CFR is no longer below the threshold in response to (b).

7. The method of claim 6, wherein the method further comprises the steps of calculating the CPDS and the AR from data gathered from a first camera monitoring coil formation in the wire rod mill and a second camera or a laser measuring coil height in the wire rod mill.

8. The method of claim 7, wherein the first camera checks an outer edge of coils being deposited in a coil plate in the reform area of the wire rod mill to ensure it is being formed smooth and that coils are falling perpendicular to the coil plate and a reform chamber axis.

9. The method of claim 7, wherein the method further comprises:
detecting, via the first camera, a stepped coil formation based on either of these, or a combination of these, conditions: (1) the RDS is slow causing coil rings from a cooling conveyor to clump, or (2) the CPDS is variable; and
increasing the RDS by a fourth predetermined amount and checking if the CPDS is no longer variable.

10. The method of claim 7, wherein the method further comprises:
detecting, via the first camera, coil rings are formed in a slanted manner; and
adjusting a position of a cooling conveyor relative to the reform area and/or modifying an exit roller speed of the cooling conveyor to ensure coil rings are entering the reform area at a predetermined speed.

11. A system comprising:
(a) a plurality of cameras monitoring coil height and coil formation in a reform area of a wire rod mill;
(b) a storage storing computer readable program code;
(c) a processor executing the computer readable program code stored in the storage to:
(1) receive data from the plurality of cameras;
(2) calculating a coil plate descent speed (CPDS) and an accumulation rate (AR) from received data from the plurality of cameras;
(3) calculating a coil formation rate (CFR) from the CPDS and the AR;
(4) when the CFR is below a threshold, either:
increasing the CPDS by a first predetermined amount; or
increasing a ring distributor speed (RDS) by a second predetermined amount and decreasing a coil plate speed (CPS) by a third predetermined amount; and
(5) sampling the AR in the reform area and iteratively repeating (1) through (4) until accumulated coil height is below an optimal coil height and the CFR is no longer below the threshold in response to (4).

12. The system of claim 11, wherein at least one camera within the plurality of cameras checks an outer edge of coils being deposited in a coil plate in the reform area of the wire rod mill to ensure it is being formed smooth and that coils are falling perpendicular to the coil plate and a reform chamber axis.

13. The system of claim 11, wherein the processor executes the computer readable program code stored in storage to:
detect, via at least one camera in the plurality of cameras, formation of a stepped coil based on either of these, or a combination of these, conditions: (1) the RDS is slow causing coil rings from a cooling conveyor to clump, or (2) the CPDS is variable; and
increase the RDS by a fourth predetermined amount and checking if the CPDS is no longer variable.

14. The system of claim 11, wherein the processor executes the computer readable program code stored in storage to:
detect, via at least one camera in the plurality of cameras, formation of coil rings in a slanted manner; and
adjust a position of a cooling conveyor relative to the reform area and/or modify an exit roller speed of the cooling conveyor to ensure coil rings are entering the reform area at a predetermined speed.

15. A system comprising:
(a) a plurality of cameras monitoring coil height and coil formation in a reform area of a wire rod mill;
(b) a storage storing computer readable program code;
(c) a processor executing the computer readable program code stored in the storage to:
(1) receive data from the plurality of cameras;
(2) calculating a coil plate descent speed (CPDS) and an accumulation rate (AR) from received data from the plurality of cameras;
(3) calculating a coil formation rate (CFR) from the CPDS and the AR;
(4) when the CFR is below a threshold: increasing the CPDS by a first predetermined amount; increasing a ring distributor speed (RDS) by a second predetermined amount, and decreasing a coil plate speed (CPS) by a third predetermined amount; and
(5) sampling the AR in the reform area and iteratively repeating (1) through (4) until accumulated coil height is below an optimal coil height and the CFR is no longer below the threshold in response to (4).

16. The system of claim 15, wherein at least one camera within the plurality of cameras checks an outer edge of coils being deposited in a coil plate in the reform area of the wire rod mill to ensure it is being formed smooth and that coils are falling perpendicular to the coil plate and a reform chamber axis.

17. The system of claim 15, wherein the processor executes the computer readable program code stored in storage to:
detect, via at least one camera in the plurality of cameras, formation of a stepped coil based on either of these, or a combination of these, conditions: (1) the RDS is slow causing coil rings from a cooling conveyor to clump, or (2) the CPDS is variable; and
increase the RDS by a fourth predetermined amount and checking if the CPDS is no longer variable.

18. The system of claim 15, wherein the processor executes the computer readable program code stored in storage to:
detect, via at least one camera in the plurality of cameras, formation of coil rings in a slanted manner; and
adjust a position of a cooling conveyor relative to the reform area and/or modify an exit roller speed of the cooling conveyor to ensure coil rings are entering the reform area at a predetermined speed.
